(19) United States
(12) Patent Application Publication
(10) Pub. No.: US 2015/0144058 A1
(43) Pub. Date: May 28, 2015

(54) DEVICE FOR COATING OR ENCLOSING PARTICLES

(71) Applicant: Glatt Maschinen-und Apparatebau AG, Pratteln (CH)

(72) Inventors: Frank Maurer, Inzlingen (DE); Pascal Ueberschlag, Fislis (FR)

(73) Assignee: Glatt Maschinen-und Apparatebau AG, Pratteln (CH)

(21) Appl. No.: 14/406,345

(22) PCT Filed: Jun. 6, 2013
(86) PCT No.: PCT/EP2013/001666

§ 371 Date: Dec. 8, 2014

(30) Foreign Application Priority Data
Jun. 8, 2012 (DE) 10 2012 011 286.6

(51) Int. Cl. B05B 3/02

(52) U.S. Cl. CPC B05B 3/02
USPC 118/64

(57) ABSTRACT

The invention relates to a device for coating or encapsulating particles, including a drum (2) which is mounted in a drum chamber (1) of the device in a rotationally drivable manner and which drum (2) can be filled with the product to be coated or to be encapsulated, at least one spray nozzle, which is provided for applying a liquid to the product that is located in the drum (2), at least one drying gas inlet (5) that penetrates the chamber wall of the drum chamber (1), through which drying gas inlet a drying gas can be introduced into the drum chamber (1) and including at least one drying gas outlet (9) that is near the drum (2) on the outer side for channeling the drying gas out of the device. The device according to the invention is characterized in that a deflector surface (6) is interposed in the flow path between the at least one drying gas inlet (5) and the drum (2), which deflector surface defines at least one flow-through opening (7), the total clear opening surface area of which is smaller in comparison to the total clear opening surface area of the at least one drying gas inlet (5). By means of the deflector surface (6) it is achieved that the drying gas flows out of the at least one flow-through opening (7) in a uniform and decelerated manner, so that irregular coatings of the product or the appearance of function-impairing build-ups in the drum chamber (1) are effectively prevented.

### BACKGROUND

The invention relates to a device for coating or encapsulating particles, with a drum which is mounted in a drum chamber of the device in a rotationally drivable manner and which can be filled with the product to be coated or to be encapsulated, with at least one spray nozzle, which is provided for applying a liquid to the product located in the drum, with at least one drying gas inlet which penetrates the chamber wall of the drum chamber and through which a drying gas can be introduced into the drum chamber, and with at least one drying gas outlet which is near the drum on the outer side and which serves for channeling the drying gas out of the device.

Devices of the type mentioned above, which are also referred to as coaters, are already known in various forms, particularly in the pharmaceutical industry. Such coaters generally have a drum, which is mounted in a rotationally drivable manner in a drum chamber of the device. To be able to fill the drum with the product that is to be coated or to be encapsulated, the drum chamber, which in most cases matches the shape of the drum and is generally likewise substantially cylindrical, has a closeable charging opening that leads into the interior of the drum. At least one spray nozzle is provided in the interior of the drum, by means of which spray nozzle a liquid, which forms the coating or cover, is applied to the product located in the drum. The previously known coaters have at least one drying gas inlet, which penetrates the chamber wall of the drum chamber, and through which dry air or another drying gas can be introduced into the drum chamber in such a way that the drying gas flows through the drum formed on all sides by a perforated plate. In this way, the product located in the slowly rotating drum, and wetted with the sprayed-on liquid, is at the same time dried, such that a thin layer of the substance contained in the liquid forms on the product. The previously known coaters have a drying gas outlet which is arranged slightly offset in the direction of rotation on the outer circumference of the drum and through which the exhaust air coming from the drum can be channeled out of the device.

The aim is to ensure that the coated or encapsulated product then has a uniformly thick layer or cover about its entire outer circumference. To achieve this aim, it is necessary that the drying gas can flow uniformly through the drum with the product located therein. However, the drying gas flows through the at least one drying gas inlet at high speed, as a consequence of which an underpressure can arise directly in the area of the drum chamber adjoining the drying gas inlet, which underpressure sucks the liquid in its direction. Moreover, the uneven distribution of the drying gas, on the one hand, and the liquid intended for the coating or encapsulating, on the other hand, can lead to the occurrence of caking in the coater and, finally, to an uneven coating or encapsulating of the product.

### SUMMARY

The object is therefore, in particular, to make available a device of the type mentioned at the outset in which a non-uniform application of the coating or cover to the product and the function-impairing occurrence of caking in the device by a non-uniform distribution of the drying gas or of the liquid intended for the coating or encapsulating are avoided.

According to the invention, this object is achieved, in the device of the type mentioned at the outset, in particular by virtue of the fact that a deflector surface is interposed in the flow path between the at least one drying gas inlet and the drum, which deflector surface defines at least one through-flow opening, the total clear opening surface area of which is smaller in comparison to the total clear opening surface area of the at least one drying gas inlet.

In the device according to the invention, a deflector surface is provided which is interposed in the flow path between the at least one drying gas inlet and the drum. This deflector surface defines at least one through-flow opening, the total clear opening surface area of which is smaller in comparison to the total clear opening surface area of the at least one drying gas inlet. Since the through-flow opening defined by the deflector surface is smaller in comparison to the drying gas inlet, the drying gas encounters a resistance that decelerates the flow velocity, and the drying gas builds up between the deflector surface and the wall of the drum chamber with the drying gas inlet, in such a way that the drying gas can distribute itself uniformly across the through-flow opening(s). Since the drying gas flows uniformly and more slowly from the at least one through-flow opening, uneven coatings or encapsulations of the product or else cakings in the drum chamber are effectively avoided.

The production of the device according to the invention is made easier, and the design of the deflector surface is simplified, if the deflector surface is provided in the area of an end face of the drum chamber.

In a preferred embodiment according to the invention, the drum chamber has a charging opening which is located at one end face and which leads to the interior of the drum chamber, and the deflector surface is arranged between the end face of the drum chamber, directed away from the charging opening, and the drum.

It is possible that the deflector surface is formed by a perforated wall that has a multiplicity of through-flow openings. Such a design, in which the deflector surface is formed by a perforated wall, affords advantages in particular in larger devices with a drum chamber of considerable volume and size.

However, in an embodiment according to the invention that is of particularly simple design and can be produced at low cost, provision is additionally or alternatively made that the deflector surface defines, between itself and the circumferential wall of the drum chamber, an annular gap configured as a through-flow opening.

The deflector surface can be designed to be positioned particularly easily between the drum and the adjacent end wall of the drum chamber if the deflector surface is plate-shaped and is arranged in a plane parallel to the adjacent end face of the drum chamber.

In a preferred embodiment according to the invention, the deflector surface has a round outer circumference, and the drum chamber has a round cross section in the area of the deflector surface. If, in this embodiment, the deflector surface has just a slightly smaller diameter in comparison to the cross section of the drum chamber, a through-flow opening configured as an annular gap is defined between, on the one hand, the outer circumference of the deflector surface and, on the other hand, the inner circumference of the drum chamber.

In a preferred embodiment according to the invention, the deflector surface is mounted rotatably in the drum chamber, and, for this purpose, the deflector surface is connected to the drum preferably for conjoint rotation therewith. Since the deflector surface in this embodiment is connected to the drum for conjoint rotation therewith and since the drum is mounted in a rotatably drivable manner in the drum chamber, the deflector surface is able to rotate together with the drum in the drum chamber. The rotation of the deflector surface additionally promotes a uniform distribution of the built-up drying gas between the deflector surface and the adjacent end wall of the drying chamber.

In an embodiment according to the invention that permits particularly simple handling, the flat side of the deflector surface directed away from the drum is configured as a standing surface for the drum in the event of the latter being dismantled from the drum chamber. In this embodiment, the deflector surface, connected to the drum for conjoint rotation therewith, can at the same time serve, on its flat side directed away from the drum, as a standing surface on which the drum can be placed, for example for cleaning purposes.

### BRIEF DESCRIPTION OF THE DRAWINGS

Developments according to the invention will become clear from the following description in conjunction with the claims and the drawing. The invention is described in yet more detail below on the basis of a preferred illustrative embodiment.

FIG. 1 shows the drum chamber of a device for coating or encapsulating particles, wherein the end face of this drum chamber that has a charging opening can be seen,

FIG. 2 shows the drum chamber from FIG. 1 in a plan view looking at the top face of this drum chamber, wherein a drive unit, for a drum mounted in a rotationally drivable manner in the drum chamber, and the air inlet and air outlet connections of this drum chamber can be seen,

FIG. 3 shows the drum chamber from FIGS. 1 and 2 in a perspective side view looking at the end wall of the drum chamber that has the charging opening, and

FIG. 4 shows the drum chamber from FIGS. 1 to 3 in a perspective side view looking at the drive side or rear end wall of the drum chamber.

### DETAILED DESCRIPTION OF THE PREFERRED EMBODIMENTS

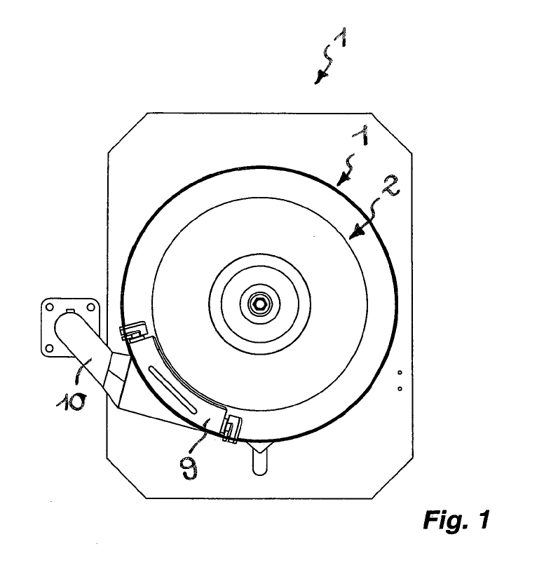

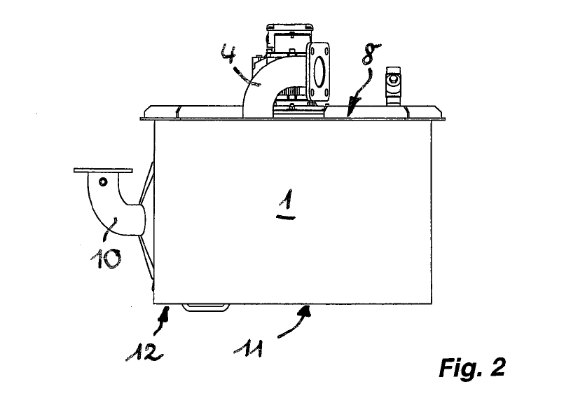

A drum chamber 1 is shown in various views in FIGS. 1 to 4. The drum chamber 1 is installed in a coater or similar device (not shown further here) that is intended for coating or encapsulating particles. A drum 2 is provided in the drum chamber 1 and is mounted in a rotationally drivable manner about an axis 3, which is here oriented approximately horizontally. This drum 2, which slowly rotates during the operation of the device, can be filled with the product that is to be coated or to be encapsulated.

A spray bar is arranged in the drum 2, on which spray bar at least one spray nozzle is provided for applying a liquid to the product located in the drum 2. A pipe connection 4 is provided on the drum chamber 1 as an attachment for drying gas, and the stub end of the pipe connection 4 that penetrates the chamber wall of the drum chamber 1 forms a drying gas inlet 5. Through this drying gas inlet 5, air or another drying gas can be introduced into the drum chamber 1. This drying gas flowing through the drum chamber 1 and the drum 2 has to dry the product located in the drum 2, and wetted with the liquid serving for the coating or encapsulating, in such a way that the material contained in the liquid forms as uniform as possible a layer or cover on the product.

The aim is to ensure that the coated or encapsulated product then has a uniformly thick layer or cover about its entire outer circumference. To achieve this aim, it is necessary that the drying gas can flow uniformly through the drum 2 with the product located therein. However, the drying gas flows through the drying gas inlet 5 at high speed into the drum chamber 1. In order to avoid, on the one hand, an uneven distribution of the drying gas and, on the other hand, an occurrence of caking in the drum chamber 1, which impairs the function of the device, provision is made, in the device with the drum chamber 1 shown here, that a deflector surface 6 is interposed in the flow path between the at least one drying gas inlet 5 and the drum 2, which deflector surface 6 defines at least one through-flow opening 7, the total clear opening surface area of which is smaller in comparison to the total clear opening surface area of the at least one drying gas inlet 5. In the device with the drum chamber 1 shown here, a deflector surface 6 is therefore provided which is interposed in the flow path between the at least one drying gas inlet 5 and the drum 2. This deflector surface 6 defines at least one through-flow opening 7, the total clear opening surface area of which is smaller in comparison to the total clear opening surface area of the at least one drying gas inlet 5. Since the through-flow opening 7 defined by the deflector surface 6 is smaller in comparison to the drying gas inlet 5, the drying gas encounters a resistance that decelerates the flow velocity, and the drying gas builds up between the deflector surface 6 and the wall of the drum chamber with the drying gas inlet 5, in such a way that the drying gas can distribute itself uniformly across the through-flow opening(s) 7. Since the drying gas flows uniformly and more slowly from the at least one through-flow opening 7, uneven coatings or coverings of the product or cakings in the drum chamber 1 are effectively avoided.

The deflector surface 6 here has a circular outer circumference. At least in the area of the deflector surface 6, the drum chamber 1 also has a round, clear cross section. The deflector surface 6 is connected in rotation to the here cylindrical drum 2 and rotates with the latter in the interior of the drum chamber 1. The flat side of the deflector surface 6 directed away from the drum 2 can be configured as a standing surface for the drum 2 in the event of the latter being dismantled from the drum chamber 1, for example for cleaning purposes.

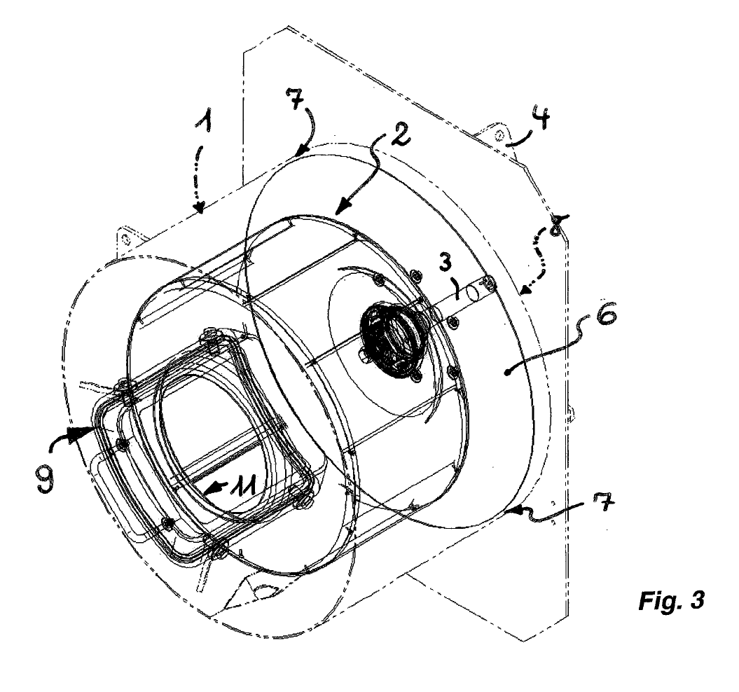

The deflector surface 6, with its circular outer circumference, has a diameter which is slightly smaller in comparison to the likewise round drum chamber 1 in the clear cross section of its drum chamber interior. As is indicated in FIG. 3, the deflector surface 6 thus defines, between itself and the circumferential wall of the drum chamber 2, an annular gap which forms the through-flow opening 7. The deflector surface 6 provides a resistance to the drying gas flowing in through the drying gas inlet 5, which resistance causes the drying gas to build up slightly and distribute itself uniformly in the space arranged between the deflector surface 6 and the adjacent end wall 8 of the drum chamber, such that the drying gas then flows with a uniform distribution and at a reduced speed out of the through-flow opening 7 designed as an annular gap. The drying gas thus flowing with uniform distribution into the drum chamber 1 is then guided through the drum 2, formed all the way round by an air-permeable perforated plate, to a drying gas outlet 9 which is near to the drum 2 on the outer side in the area of the product located in the drum 2 and is intended to channel the drying gas out of the drum chamber 1. The drying gas outlet 9 likewise leads to a pipe connection 10, into which the exhaust air is forwarded and channeled out of the device.

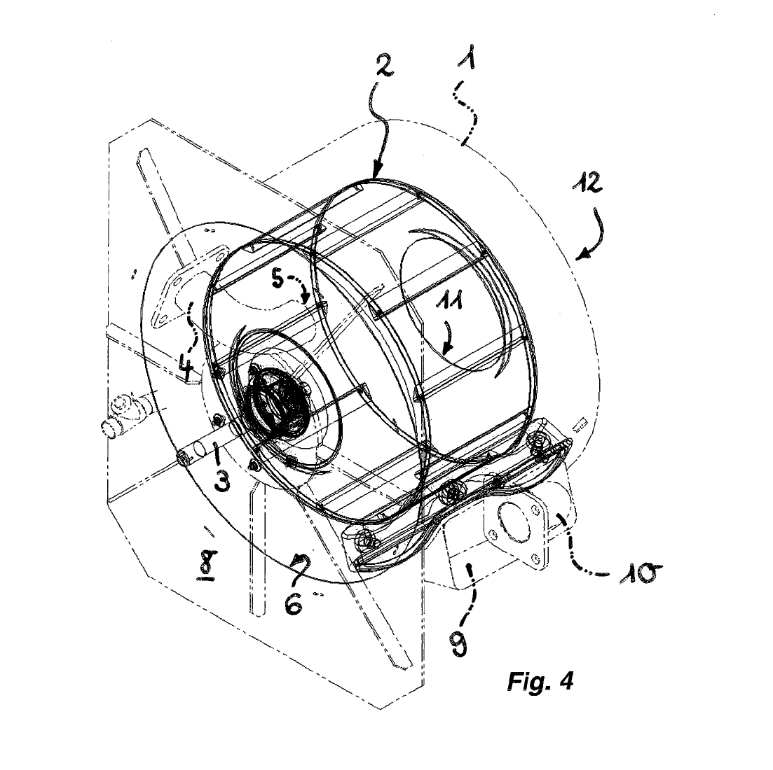

The drum chamber 1 has a substantially closed configuration, except for the drying gas inlet 5, the drying gas outlet 9 and a charging opening 11. The charging opening 11 can be opened and closed and leads into the interior of the drum chamber, such that the product can be introduced and removed by way of the charging opening 11. In the perspective views according to FIGS. 3 and 4, shown like X-rays, it can be seen that the charging opening 11 leading to the interior of the drum is arranged on an end face 12 of the drum chamber 1, and that the deflector surface 6 is arranged between the end face 8 of the drum chamber 1, directed away from the charging opening 11, and the drum 2.

### LIST OF REFERENCE SIGNS

1 drum chamber
2 drum
3 axis (of the drum 2)
4 pipe connection (to the drying gas inlet 5)
5 drying gas inlet
6 deflector surface
7 through-flow opening (defined by the deflector surface 6)
8 end wall of drum chamber (adjacent to the deflector surface 6)
9 drying gas outlet
10 pipe connection (on the drying gas outlet 9)
11 charging opening
12 end face of drum chamber (with the charging opening 11)

1. A device for coating or encapsulating particles, comprising a drum (2) mounted in a drum chamber (1) in a rotationally drivable manner and which is fillable with product to be coated or to be encapsulated, at least one spray nozzle, which is provided for applying a liquid to the product located in the drum (2), at least one drying gas inlet (5) which penetrates a chamber wall of the drum chamber (1) and through which a drying gas is introducable into the drum chamber (1), and at least one drying gas outlet (9) near the drum (2) on an outer side thereof for channeling the drying gas out of the device, a deflector surface (6) interposed in a flow path between the at least one drying gas inlet (5) and the drum (2), said deflector surface (6) defines at least one through-flow opening (7), a total clear opening surface area of which is smaller in comparison to a total clear opening surface area of the at least one drying gas inlet (5).

2. The device as claimed in claim 1, wherein the deflector surface (6) is provided in an area of an end face (8) of the drum chamber.

3. The device as claimed in claim 1, wherein the drum chamber (2) has a charging opening (11) which is located at one end face and which leads to an interior of the drum, and the deflector surface (6) is arranged between an end face (8) of the drum chamber (1), directed away from the charging opening (11), and the drum (2).

4. The device as claimed in claim 1, wherein the deflector surface (6) is formed by a perforated wall that has a multiplicity of through-flow openings.

5. The device as claimed in claim 1, wherein the deflector surface (6) defines, between itself and a circumferential wall of the drum chamber (2), an annular gap configured as at least one of the through-flow openings (7).

6. The device as claimed in claim 1, wherein the deflector surface (6) is plate-shaped and is arranged in a plane parallel to an adjacent end face (8) of the drum chamber.

7. The device as claimed in claim 1, wherein the deflector surface (6) has a round outer circumference, and the drum chamber (1) has a round, clear cross section in an area of the deflector surface (6).

8. The device as claimed in claim 1, wherein the deflector surface (6) is mounted rotatably in the drum chamber (1), and the deflector surface (6) is connected to the drum (2) for conjoint rotation therewith.

9. The device as claimed in claim 1, wherein a flat side of the deflector surface (6) directed away from the drum (2) is configured as a standing surface for the drum (2).
